(19) United States
(12) Patent Application Publication
(10) Pub. No.: US 2014/0215024 A1
(43) Pub. Date: Jul. 31, 2014

(54) Multi-Level Media Communications Content and Message Delivery and Response

(71) Applicant: Live365, Inc., Foster City, CA (US)

(72) Inventors: Kevin LIAO, Foster City, CA (US); Joe Y. FONG, Sunnyvale, CA (US); Yung-Chang Chen, Danville, CA (US); Lex CHIANG, Newark, CA (US)

(73) Assignee: LIVE365, INC., Foster City, CA (US)

(21) Appl. No.: 14/165,049

(22) Filed: Jan. 27, 2014

Related U.S. Application Data
(60) Provisional application No. 61/757,211, filed on Jan. 27, 2013.

(51) Int. Cl. H04L 29/06

(52) U.S. Cl. CPC H04L 65/602
USPC 709/219

(57) ABSTRACT

A method and system for multimedia broadcasting including dynamically modifying the digital broadcast stream by injecting additional digital content into the digital broadcast stream is disclosed.

### CROSS REFERENCE TO RELATED APPLICATIONS

This application claims the benefit of U.S. Provisional Patent Application No. 61/757,221 filed Jan. 27, 2013, entitled, “ Multi-Level Media Communications Content and Message Delivery and Response,” by Liao et al., and which is hereby incorporated by reference in its entirety.

### TECHNICAL FIELD

The present invention is directed to electronic communications, and more specifically to aspects of broadcasting technology.

### BRIEF DESCRIPTION OF THE DRAWINGS

FIG. 1 is a high-level network diagram showing aspects of a computerized environment in which an individual broadcaster may insert single media or multimedia messages into a network audio/media content stream, according to certain embodiments.

FIG. 2 is a high-level network diagram showing aspects of a computerized environment in which multiple broadcasters may insert single media or multimedia messages into multiple network audio/media content streams, according to certain embodiments.

### DETAILED DESCRIPTION

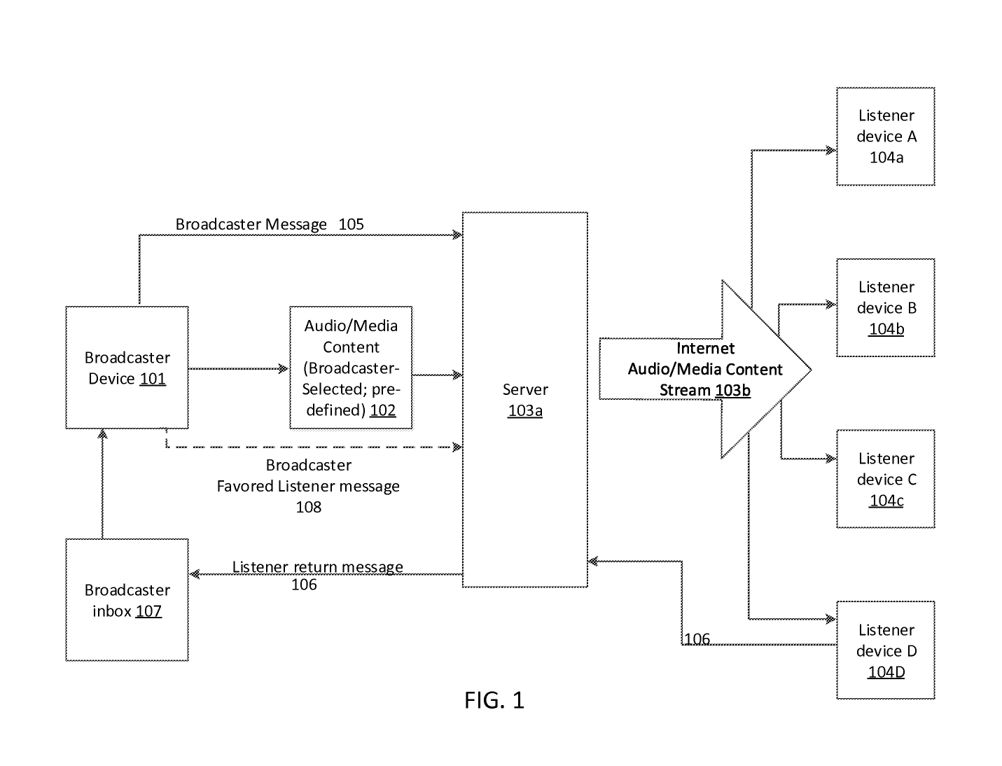

FIG. 1 is a high-level network diagram showing aspects of a computerized environment in which an individual broadcaster may insert single media or multimedia messages into a network audio/media content stream, according to certain embodiments.

According to certain embodiments, the network in FIG. 1 may be an

Internet, intranet or extranet. Further, the network may be a distributed network.

FIG. 1 shows a broadcaster device (101), audio/media content (102), server instance (103a), network audio/media content stream (103b), listener devices (104a-104d), broadcaster message (105), listener return message (106), broadcaster inbox (107), and broadcaster's-favored listener return message (108). The messages (105, 106, 108) referenced herein can include sound, or image, or animation, or video, or text, or graphics, either alone or any combination thereof.

According to certain embodiments of the invention, one level of communication involves an individual broadcaster that selects, via use of a mobile or other electronic device (101) (herein referred to as a “broadcaster device), audio/media content (102) that is fixed, saved and maintained on a server instance (103a) and inserted into a network audio/media content stream (103b). Audio/media content includes sound, or image, or animation, or video, or text, or graphics, either alone or any combination thereof. The audio/media content (102) may be selected by the broadcaster via use of the broadcaster device (101) in any manner, including from audio/media files (e.g., “tracks”) or from other available files to create a customized audio/media content (102) “playlist” or from a non-customized, pre-defined audio/media content playlist (as created by a third-party) and that the broadcaster can include in the broadcaster's audio/media content stream (103b). It is to be understood that there may be multiple server instances that are associated with one or more servers in the network.

That audio/media content (102) is inserted by the broadcaster via use of the broadcaster device (101) into the network audio/media content stream (103b) after being processed by server instance (103a), and thereby delivered to one or more listener devices (104a-104d) via the network to desktop, mobile, and other client applications (using an HTTP API).

For another level of communication, broadcasters may create customized messages with any content (audio or video or image or graphics or text, either alone or any combination thereof) desired by the broadcaster, known as a “broadcaster message” (105) via use of the broadcaster device (101) to fix and maintain that message, including by saving the message as an MP3 file. The broadcaster message (105) may then be sent by the broadcaster device (101) to server instance (103a) via an HTTP API, for example, and thereby inserted directly into the network audio/media content stream (103b) for instantaneous, near-instantaneous, or other time interval communication of the broadcaster message (105) to one or more listener devices (104a-104d) on one or more occasions determined by the broadcaster. By way of example, a broadcaster message (105) may be inserted into the network audio/media content stream (103) to be received by listeners through listener devices (104a-104d) as follows: (1) when any listener hits “play” on the listener device to start the stream (known as “pre-roll” play of the message); (2) at defined time intervals such as one play every 10 minutes between tracks; (3) immediately after completion of a track, such as playing after the currently playing track completes; (4) instantaneous presentation of the message in the network audio/media content stream (103) regardless of the track playing at that time (to explain, instantaneous presentation of the message includes inserting a message into the one or more network audio/media content streams even while a track is playing); or (5) any combination of these message play methods.

Listeners may communicate, record, fix and preserve one or more messages known as a “listener return message” (106), via listener devices (104a-104d). Such listener return messages (106) can be sent to the broadcaster device (101). Listener return messages (106) may include content that is audio or video or image or graphics or text, either alone or any combination thereof. Listener return messages (106) may be saved as MP3 files and sent by the listener devices (104) back to server instance (103a) via an HTTP API to be delivered to the broadcaster's inbox (107) for the broadcaster to review.

As an additional level of communication, the broadcaster, via use of broadcaster device (101) may insert a “broadcaster's-favored listener return message” (108) that the broadcaster desires into the broadcaster's network audio/media content stream (103b) using the same or similar method as disclosed herein to insert the broadcaster message (105).

Thus, according to certain embodiments of the invention, any listener via listener device (104a-104d), including the sender of the listener return message (106) may receive, based on the broadcaster's choice, via a network audio/media content stream (103b), opportunities to enjoy the broadcaster's selected or defined audio/media content (102), the broadcaster's instantaneous or near-instantaneous broadcaster messages (105), and the broadcaster's-favored listener return messages (108). According to certain embodiments, the content of broadcaster messages (105), listener return messages (106) and broadcaster's-favored listener return message” (108) are managed for storage, retrieval, and subsequent use by the broadcaster.

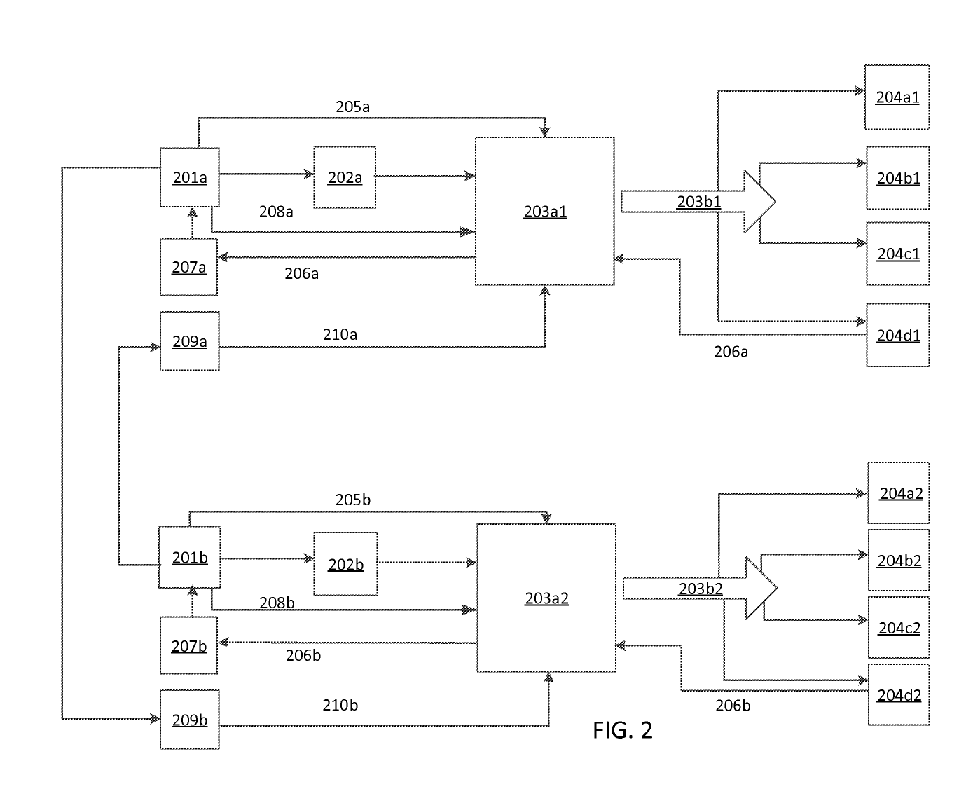

FIG. 2 is a high-level network diagram showing aspects of a computerized environment, in which multiple broadcasters may insert single media or multimedia messages into multiple network audio/media content streams, according to certain embodiments. For example, a broadcaster can insert his/her own single media or multimedia messages or another broadcaster's single media or multimedia messages into the network audio/media content stream, according to certain embodiments. The single media or multimedia messages from various broadcasters can be sent to broadcaster group inboxes as explained in greater detail herein.

According to certain embodiments, the networks in FIG. 2 may be the

Internet, intranets or extranets. Further, the network may be a distributed network.

According to certain embodiments, broadcasters may form groups and/or subgroups. Each broadcaster of at least a subset of broadcasters within a group or subgroup may selectively insert broadcaster messages and/or favored listener return messages into one or more network audio/media content streams of other broadcasters within the group or subgroup by using one or more “broadcaster group inboxes”, for example. Further, according to certain embodiments, a given broadcaster may belong to more than one group or subgroup.

In the interest of efficiency, FIG. 2 shows only two sets of representations such as 2 sets of server instances, 2 sets of network audio/media content streams, 2 sets of broadcaster devices, listener devices and associated messages and inboxes, etc. It is to be understood that FIG. 2 represents a plurality of broadcasters (for example, N number of broadcasters where N is a positive integer) and their associated devices, a plurality of server instances (for example, P number of server instances, where P is a positive integer) associated with one or more servers, a plurality of network audio/media content streams (for example, Q number of network audio/media content streams, where Q is a positive integer), a plurality of listeners (for example, R number of listeners, where R is a positive integer) and their associated devices. The value of each of N, P, Q, and R may be equal to one another or different than one another. Similarly, there may be a plurality of broadcaster inboxes, a plurality of broadcaster group inboxes, a plurality of broadcaster messages, a plurality of listener return messages, and a plurality of broadcaster's-favored listener return messages.

FIG. 2 shows broadcaster devices (201a, 201b), audio/media content (202a, 202b), server instances (203a1, 203a2), network audio/media content streams (203b1, 203b2), listener devices (204a1-204d1, 204a2-204d2), broadcaster messages (205a, 205b), listener return messages (206a, 206b), broadcaster inboxes (207a, 207b), broadcaster's-favored listener return messages (208a, 208b), broadcaster group inboxes (209a, 209b), and broadcaster group messages (210a, 210b). The messages (205a, 206a, 208a, 210a, 205b, 206b, 208b, 210b) referenced herein can include sound, or image, or animation, or video, or text, or graphics, either alone or any combination thereof.

According to certain embodiments of the invention, one level of communication involves a plurality of broadcasters that can select, via use of a mobile or other electronic devices (201a, 201b) (herein referred to as a “broadcaster device), audio/media content (202a, 202b) that are fixed, saved and maintained on server instances (203a1, 203a2) and inserted into network audio/media content streams (203b1, 203b2). It is to be understood that there may be multiple server instances that are associated with one or more servers. Audio/media content includes sound, or image, or animation, or video, or text, or graphics, either alone or any combination thereof. The audio/media content (202a, 202b) may be selected by the plurality broadcasters via use of the broadcaster devices (201a, 201b) in any manner, including from audio/media files (e.g., “tracks”), or from other available files to create a customized audio/media content (202a, 202b) “playlist” or from a non-customized, pre-defined audio/media content playlist (as created by a third-party) and that the broadcasters can include in the broadcasters' network audio/media content streams (203b1, 203b2).

That audio/media content (202a, 202b) are inserted by the broadcasters via use of the broadcaster devices (201a, 201b) into the network audio/media content streams (203b1, 203b2) after being processed by server instances (203a1, 203a2), and thereby delivered to one or more listener devices (204a1-204d1, 204a2-204d2) via the network to web, desktop, mobile, and other client applications (using an HTTP API), for example.

For another level of communication, broadcasters may create customized messages with any content (audio or video or image or graphics or text, either alone or any combination thereof) desired by a respective broadcaster, known as respective “broadcaster messages” (205a, 205b) via use of the broadcaster devices (201a, 201b) to fix and maintain those messages, including by saving the messages as MP3 files. The respective broadcaster messages (205a, 205b) may then be sent by the broadcaster devices (201a, 201b) to the server instances (203a1, 203a2) via an HTTP API, for example, and thereby inserted directly into the network audio/media content stream (203b1, 203b2) for instantaneous, near-instantaneous, or other time interval communication of the respective broadcaster messages (205a, 205b) to one or more listener devices (204a1-204d1, 204a2-204d2) on one or more occasions determined by the respective broadcasters.

By way of example, assume there are N broadcasters, where N is a positive integer. “Broadcaster J” of the N number of broadcasters may insert a broadcast message (205a) via use of a broadcaster device (201a) into one or more network audio/media content streams (203b1) of the plurality of network audio/media content streams to be received by one or more listeners through listener devices (204a1-204d1) as follows: (1) when any listener hits “play” on the listener device to start the stream (known as “pre-roll” play of the message); (2) at defined time intervals such as one play every 10 minutes between tracks; (3) immediately after completion of a track, such as playing after the currently playing track completes; (4) instantaneous presentation of the message in the one or more network audio/media content streams (203b1) regardless of the track playing at that time (to explain, instantaneous presentation of the message includes inserting a message into the one or more network audio/media content streams even while a track is playing); or (5) any combination of these message play methods. It is to be understood that some of the listeners may listen to different broadcasters at different times.

Similarly, “Broadcaster K” of the N number of broadcasters, may insert, independently of “Broadcaster J”, a broadcast message (205b) via use of a broadcaster device (201b) into one or more network audio/media content streams (203b2) of the plurality of network audio/media content streams to be received by one or more listeners through listener devices (204a2-204d2) as follows: (1) when any listener hits “play” on the listener device to start the stream (known as “pre-roll” play of the message); (2) at defined time intervals such as one play every 10 minutes between tracks; (3) immediately after completion of a track, such as playing after the currently playing track completes; (4) instantaneous presentation of the message in the one or more network audio/media content streams (203b2) regardless of the track playing at that time (to explain, instantaneous presentation of the message includes inserting a message into the one or more network audio/media content streams even while a track is playing); or (5) any combination of these message play methods. It is to be understood that some of the listeners may listen to different broadcasters at different times.

Assuming there are R number of listeners, at least a subset of the R number listeners may communicate, record, fix and preserve messages known as a “listener return messages” (206a, 206b), via use of listener devices (204a1-204d1, 204a2-204d2). Such listener return messages (206a, 206b) can be sent to the broadcaster devices (201a, 201b) via server instances (203a1, 203a2). Listener return messages (206a, 206b) may include content that is audio or video or image or graphics or text, either alone or any combination thereof. Listener return messages (206a, 206b) may be saved as MP3 files and sent by the listener devices (204a1-204d1, 204a2-204d2) back to one or more of the server instances (203a1, 203a2) via an HTTP API to be delivered to one or more of the broadcaster's inboxes (207a, 207b) for the broadcaster to review.

As an additional level of communication, the broadcasters, via use of broadcaster devices (201a, 201b) may insert a “broadcaster's-favored listener return message” (208a, 208b) that the broadcasters desire into the broadcaster's network audio/media content streams (203b1, 203b2) using the same or similar method as disclosed herein to insert the broadcaster messages (205a, 205b).

According to certain embodiments, assume that “Broadcaster J” and

“Broadcaster K” belong to the same group. As another level of communication, “Broadcaster K” may selectively insert broadcaster messages and/or favored listener return messages [collectively referred to as “broadcast group message” (210a)] into one or more network audio/media content streams associated with “Broadcaster J” by using “broadcaster group inbox” 209a. Similarly, “Broadcaster J” may selectively insert broadcaster messages and/or favored listener return messages (collectively referred to as “broadcast group message” 210b) into one or more network audio/media content streams associated with “Broadcaster K” by using “broadcaster group inbox” 209b. It is to be understood that any number of subsets of the N number of broadcasters may form groups and subgroups.

Each level of communication described herein may occur between and among multiple groups and subgroups using similar environments. Thus, a given broadcaster within a selected group may insert messages into network audio/media streams of other broadcasters within that same group to achieve two-way communication within a group or subgroup.

We claim:

1. A method of digital multimedia broadcasting, the method comprising:
creating a playlist of digital content on a computer network;
maintaining the playlist of the digital content on the computer network;
broadcasting the digital content via digital streaming to form a digital broadcast stream; and
during the digital streaming of the digital broadcast stream, dynamically modifying the digital broadcast stream by injecting additional digital content into the digital broadcast stream.

2. The method of claim 1, further comprising including audio, video, other media, and multimedia content as the digital content and the additional digital content.

3. The method of claim 1, further comprising broadcasting one or more digital broadcast streams to users and/or listeners.

4. The method of claim 1, further comprising sourcing the additional digital content from one or more sources comprising: digital content from listeners, news feeds, and advertisements.

5. The method of claim 1, further comprising enabling a broadcaster to select listeners for receiving the digital broadcast stream.

6. The method of claim 1, wherein injecting the additional digital content into the digital broadcast stream includes injecting digital content into a track while the track is playing.

7. The method of claim 1, wherein injecting the additional digital content into the digital broadcast stream occurs at one or more selected intervals.

8. The method of claim 1, wherein injecting the additional digital content into the digital broadcast stream occurs at any one of: a pre-roll and in between playing tracks.

9. The method of claim 1, wherein injecting the additional digital content includes injecting content comprising one or more of: audio, video, graphics, text, and images.

10. The method of claim 1, wherein injecting the additional digital content includes injecting content comprising broadcast group content.
